(19) United States
(12) Patent Application Publication
(10) Pub. No.: US 2017/0355848 A1
(43) Pub. Date: Dec. 14, 2017

(54) COMPOSITION COMPRISING A POLYMER BASED ON EPOXIDE COMPOUNDS

(71) Applicant: Hexion Inc., Columbus, OH (US)

(72) Inventors: Gunda KUHLMANN, Hamm (DE); Christoph Scheuer, Dinslaken (DE); Panagiotis SALTAPIDAS, Datteln (DE); Thomas Dreßen, Oberhausen (DE)

(21) Appl. No.: 15/617,781

(22) Filed: Jun. 8, 2017

(30) Foreign Application Priority Data
Jun. 8, 2016 (DE) 102016006910.4

(51) Int. Cl. C08L 63/00; C08G 59/24; C08G 59/42

(52) U.S. Cl. CPC C08L 63/00; C08G 59/4238; C08G 59/245; C08L 2205/03; C08L 2205/06

(57) ABSTRACT

The invention relates to a composition comprising components a), b) and c), to a process for the preparation thereof, and to the use thereof. In one embodiment, a composition is provided which comprises the following components a), b) and c): a) from 75 to 99.5% by weight of a polymer based on epoxide compounds, from 0.5 to 25% by weight of at least one polyhydric alcohol, and optionally additives, b) from 80 to 99% by weight of a curing agent which is suitable for curing the polymer based on epoxide compounds, from 1 to 20% by weight of a polycaprolactone-polysiloxane block copolymer, optionally an accelerator, and optionally additives, and c) optionally an accelerator.

This application claims the benefit of German Patent Application No. 102016006910.4 filed Jun. 8, 2016, the contents of which are hereby incorporated by reference.

The invention relates to a composition comprising a polymer based on epoxide compounds, to a process for the preparation thereof, and to the use thereof.

Polymers based on epoxide compounds are mostly reaction products of polyfunctional hydroxyl compounds with epichlorohydrin. Crosslinking of the polymer matrix takes place by polyaddition via the epoxide groups using corresponding curing agents. They are used for different types of applications. For example, they are processed as casting resins (reaction resins), molding compositions (reaction resin compositions) or as prepregs.

As casting resins they are widely used in electrical engineering, for example for producing components for electric motors, high-voltage ducts, insulators or capacitors, or also in the building industry as lacquers for surface protection and coatings, bonding of concrete structural elements, or as high-strength coverings which are resistant to chemicals. Casting resins based on epoxy resins are, however, also used as adhesives or in toolmaking.

Molding compositions of epoxy resins are used in particular in electrical engineering, for example for sheathing sensitive electrical and electronic components such as capacitors, collectors or resistors.

Laminates based on epoxy resins are used inter alia for claddings and structural elements of aircraft, rotor blades for wind turbines, boat hulls, as base material for printed circuits and circuit boards. They are also used in the sport and leisure sector as, for example, skis, hockey sticks, tennis rackets, fishing rods or high jump poles.

The broad field of application of cured epoxy resins is based on their excellent properties in respect of, for example, their good electrical insulating properties, high strength, low shrinkage, good chemical resistance and their low flammability.

Since the demands made of the products in the individual fields of application are constantly increasing, ever higher demands are also being made of the starting materials, that is to say of the cured epoxy resins.

EP 2 352 793 B1 thus describes the use of dispersible polyorganosiloxane drops and siloxane-containing block copolymers for the modification inter alia also of epoxy resins in order to increase the impact strength and impact toughness. However, it was found that the fracture toughness could not be increased to the desired level with such a composition. Similar compositions are described in U.S. Pat. No. 4,663,413 and U.S. Pat. No. 5,037,898.

The object of the present invention is to improve the fracture toughness of cured epoxy resins in order to be able to meet the demands that are nowadays made of epoxy resin materials.

The object is achieved according to the invention by a composition comprising the following components a), b) and c):

a)
from 75 to 99.5% by weight of a polymer based on epoxide compounds,
from 0.5 to 25% by weight of at least one polyhydric alcohol and
optionally additives,
   b)
from 80 to 99% by weight of a curing agent which is suitable for curing the polymer based on epoxide compounds,
from 1 to 20% by weight of a polycaprolactone-polysiloxane block copolymer,
optionally an accelerator and
optionally additives, and
   c)
optionally an accelerator.

Polymers based on epoxide compounds can be selected from the group of the polyepoxides based on cycloaliphatic or aliphatic compounds, based on bisphenol A and/or F and advancement resins produced therefrom, based on tetraglycidyl-methylenedianiline (TGMDA), based on epoxidized halogenated bisphenols and/or epoxidized novolaks and/or polyepoxide esters based on phthalic acid, hexahydrophthalic acid or based on terephthalic acid, epoxidized o- or p-aminophenols, epoxidized polyaddition products of dicyclopentadiene and phenol, based on epoxidized flourenone bisphenols.

There can thus be used as the polymer based on epoxide compounds epoxidized phenol novolaks (condensation product of phenol and, for example, formaldehyde and/or glyoxal), epoxidized cresol novolaks, polyepoxides based on bisphenol A (e.g. also product of bisphenol A and tetraglycidylmethylenedianiline), epoxidized halogenated bisphenols (e.g. polyepoxides based on tetrabromobisphenol A) and/or polyepoxides based on bisphenol F and/or epoxidized novolak and/or epoxy resins based on triglycidyl isocyanurate. These include inter alia:

Epikote® 1001, Epikote® 1004, Epikote® 1007, Epikote® 1009: polyepoxides based on bisphenol A

Epon SU8 (epoxidized bisphenol A novolak), Epon® 1031 (epoxidized glyoxal-phenol novolak), Epon® 1163 (polyepoxide based on tetrabromobisphenol A), Epikote® 03243/LV (polyepoxide based on (3,4-epoxycyclohexyl)methyl 3,4-epoxycyclohexylcarboxylate and bisphenol A), Epon® 164 (epoxidized o-cresol novolak)—all products obtainable from flexion Inc.

There are present in component a), based on all the constituents of component a), from 75 to 99.5% by weight of the polymer based on epoxide compounds. An amount of from 95 to 99.5% by weight is particularly preferred since smaller amounts lead to a generally less desirable lowering of the glass transition temperature. As a further constituent of component a) there are present, based on all the constituents of component a), from 0.5 to 25% by weight of at least one polyhydric alcohol. It is advantageous if the polyhydric alcohol is present in component a) in an amount of from 0.5 to 3% by weight since a balanced relationship between the improvement in the fracture toughness and an acceptable glass transition temperature is achieved in this concentration range. Preference is given to glycols (dihydric alcohols (diols)) which can be derived from ethylene glycol, such as, for example, ethylene glycol, propylene glycol, methyl glycol, trimethylene glycol, neopentyl glycol, diethylene glycol, triethylene glycol, polyethylene glycol and/or polypropylene glycol. The use of polypropylene glycol is particularly preferred since this compound is commercially available and hence readily accessible.

However, trivalent or higher valent alcohols can also be used, such as, for example, glycerol, trimethylolpropane, glucose and/or other sugar compounds.

Component a) can further optionally comprise additives, such as processing aids (antifoams, air-release agents), pigments and/or UV stabilizers, which are commercially available.

The main constituent of component b) is a curing agent in a concentration of from 80 to 99% by weight (based on all the constituents of component b), which curing agent is suitable for curing the polymer based on epoxide compounds. Particular preference is given to an amount of from 90 to 99% by weight since the viscosity of component b) is optimally influenced thereby.

The amount of the curing agent component in the mixture is usually governed by the epoxide equivalent (amount of resin, in grams, containing 1 mol of epoxide group) of the epoxy resin used and of the curing agent used.

There come into consideration as curing agents for the epoxy resins, for example, phenols, imidazoles, thiols, imidazole complexes, carboxylic acids, boron trihalides, novolaks, melamine-formaldehyde resins. Particular preference is given to anhydride curing agents, preferably dicarboxylic anhydrides and tetracarboxylic anhydrides or modifications thereof. The following anhydrides may be mentioned as examples at this point: tetrahydrophthalic anhydride (THPA), hexahydrophthalic anhydride (HHPA), methyltetrahydrophthalic anhydride (MTHPA), methylhexahydrophthalic anhydride (MHHPA), methylnadic anhydride (MNA), dodecenylsuccinic anhydride (DBA) or mixtures thereof. As modified dicarboxylic anhydrides there are used acid esters (reaction products of above-mentioned anhydrides or mixtures thereof with diols or polyols, for example: neopentyl glycol (NPG), polypropylene glycol (PPG, preferably molecular weight 200 to 1000).

Further preferred are curing agents selected from the group of the amine curing agents, in turn selected from the polyamines (aliphatic, cycloaliphatic or aromatic), polyamides, Mannich bases, polyaminoimidazoline, polyetheramines and mixtures thereof. There may be mentioned by way of example at this point the polyetheramines, for example Jeffamine D230, D400 (Huntsman Advance Materials LLC.), the use of which results in curing which is distinguished by low exothermy. Polyamines, for example isophoronediamine, impart a high T_{G} value to the composition, and the Mannich bases, for example Epikure 110 (flexion Inc.), are distinguished by low carbamate formation and high reactivity.

Component b) of the composition according to the invention further comprises, based on all the constituents of component b), from 1 to 20% by weight of a polycaprolactone-polysiloxane block copolymer, wherein amounts of from 1 to 10% by weight are particularly advantageous for achieving the desired efficiency of mixing at a suitable viscosity. Concentrations greater than 20% by weight lead to a significant increase in the processing viscosity. This block copolymer is known from the prior art. Corresponding block copolymers are described inter alia in U.S. Pat. No. 4,663,413 or EP 2 352 793 B1. The block copolymers A″-B-A′ to be used have the following structure:

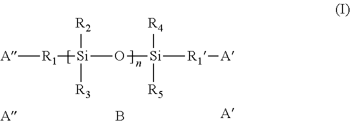

The linear block copolymer A″-B-A′ consists of an organosiloxane block B and a polylactone block A″ or A′.

n: integer between 1 and 200,

R₂, R₃, R₄, R₅: identical or independently of one another selected from linear or branched alkyl, alkenyl, haloalkyl, haloalkenyl groups having up to 6 carbon atoms; aryl groups having from 5 to 7 carbon atoms or aralkyl groups having from 6 to 8 carbon atoms,

R₁′, R₁: identical or independently of one another selected from, alkyl ethers or alkylamines having up to 7 carbon atoms,

A″ and A′: identical or independently of one another with

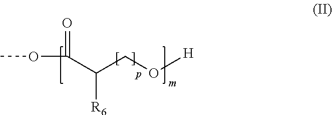

wherein
p: an integer from 1 to 6,
m: an integer from 1 to 25,
R₆: hydrogen or linear or branched alkyl groups having up to 6 carbon atoms.

There may be mentioned by way of example at this point the following compound wherein n≧1 and y>3:

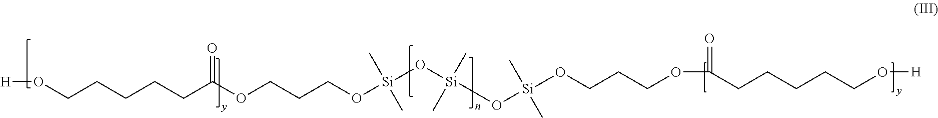

Component b) can optionally comprise as a further constituent an accelerator in conventional amounts (e.g. from 1 to 2% by weight), whereby there are suitable in principle all accelerators known from the prior art which can be used for corresponding epoxy resins.

There may be mentioned here by way of example, for example, imidazoles, substituted imidazoles, imidazole adducts, imidazole complexes (e.g. Ni-imidazole complex), tertiary amines, quaternary ammonium and/or phosphonium compounds, tin(IV) chloride, dicyandiamide, salicylic acid, urea, urea derivatives, boron trifluoride complexes, boron trichloride complexes, epoxy addition reaction products, tetraphenylene-boron complexes, amine borates, amine titanates, metal acetylacetonates, naphthenic acid metal salts, octanoic acid metal salts, tin octoates, further metal salts and/or metal chelates. There can further, for example, oligomeric polyethylenepiperazines, dimethylamino-propyldipropanolamine, bis-(dimethylaminopropyl)-amino-2-propanol, N,N′-bis-(3-dimethylaminopropyl)urea, mixtures of N-(2-hydroxypropyl)imidazole, dimethyl-2-(2-aminoethoxy)ethanol and mixtures thereof, bis(2-dimethylaminoethyl) ether, pentamethyldiethylenetriamine, dimorpholinodiethyl ether, 1,8-diazabicyclo[5.4.0]undec-7-ene, N-methylimidazole, 1,2-dimethylimidazole, triethylenediamine and/or 1,1,3,3-tetra-methylguanidine.

The mentioned accelerators can be added to component b) and/or separately as component c). The addition thereof can, however, also be omitted completely.

Additives, such as processing aids, pigments and/or UV stabilizers, which are commercially available, can again likewise be added as a constituent of component b).

Dividing the individual constituents into the components, in particular into components a) and b), utilizes the solubility of the block copolymer in the curing agent, whereby the storage stability of the composition is increased. If the block copolymer was dispersed in the epoxy resin, the storage stability is lower and a tendency to crystallization was observed.

The ratio of components a) and b) is determined in dependence on the epoxide equivalent of the resin and the equivalent mass of the curing agent used. Thus, when an anhydride curing agent, for example, is used, preferably from 70 to 100 parts of component b) are added per 100 parts of component a). If an amine curing agent is used, the ratio changes to preferably from 10 to 30 parts of component b) to 100 parts of component a).

The cured composition according to the invention is prepared by the method comprising the following steps:
preparing components a) and b),
mixing components a) and b) and optionally c) at up to 120° C.,
optionally shaping the mixture that is produced, and
curing the mixture at temperatures up to 180° C.

The preparation of components a) and b) is carried out in conventional mixing units, such as intimate mixers or extruders, generally at room temperature. Components a) and b) are stable to storage and can be used as required. The mixing of components a) and b) is likewise carried out in conventional units, whereby it is preferred, following the preparation of components a) and b), to blend components a) and b) with one another in the mixing unit which has already been used for the preparation of components a) or b), whereby the sequence is not important. Mixing can be carried out in a temperature range from room temperature to 120° C., optionally in vacuo. The ratio of components a) and b) is again generally determined by the epoxide equivalent of the resin and of the curing agent used. Thus, when an anhydride curing agent, for example, is used, preferably from 70 to 100 parts of component b) are added per 100 parts of component a). If an amine curing agent is used, the ratio changes to preferably from 10 to 30 parts of component b) to 100 parts of component a). Depending on the application for which the composition according to the invention is to be used, corresponding shaping of the mixture that is produced can be carried out. Curing then takes place at temperatures which, again in dependence on the curing agent used, can be between room temperature (e.g. amines) and 90-180° C. (e.g. anhydrides).

The composition according to the invention is used in the cured state preferably for the production of casting resins, composite compositions, coatings, adhesives and molding compositions.

The invention is to be explained in greater detail by means of the following implementation example.

TABLE 1

| | Prior | | Composition according |
|---|---|---|---|
| | art | Invention | to EP 2352793 B1 |
| Constituent | (1) | (2) | (3) |
| Epikote ® 861 | 100 | 100 | 100 |
| Polypropylene glycol | — | 1.5 | — |
| Epikure ® 871 | 95 | 95 | 95 |
| Polycaprolactone-polysiloxane | 6 | 6 | 6 |
| block copolymer | | | |
| GENIOPERL ® W35, | | | |
| Wacker | | | |
| Polydimethoxysiloxane | — | — | 1.5 |
| Quartz powder | 391 | 393 | 393 |

### Preparation of Component a) of the Composition According to the Invention (2):

1.5 parts by weight of polypropylene glycol are added at room temperature (23° C.) to 100 parts by weight of the epoxy resin Epikote® 861 and the mixture is homogenized for about 0.5 hour. The quartz powder is then added.

Preparation of component b) of the Composition According to the Invention (2):

6 parts by weight of Genioperl® W35 are dissolved, with stirring, in 95 parts by weight of the anhydride curing agent Epikure® 871 at about 70-80° C. for 1-2 hours. When the Genioperl® W35 has dissolved completely, the solution is cooled to room temperature (23° C.).

Components a) and b) are mixed together at room temperature and cured at 160° C. Test specimens for determining the fracture toughness were cut from this cured composition (Table 2).

Comparison compounds (1) and (3) from Table 1 were prepared in one step at room temperature and cured at 1.60° C. Test specimens for determining the fracture toughness were cut from the cured compositions (Table 2).

TABLE 2

| | | | Composition according to |
|---|---|---|---|
| Properties of the cured | Prior art | Invention | EP 2 352 793 B1 |
| samples | (1) | (2) | (3) |
| T_{G} [° C.] | 115 | 110 | 110 |
| Fracture toughness | 640 | 840 | 770 |
| [J/m²] | | | |

The fracture toughness was determined using a class 1 tension/compression machine in accordance with DIN 51221. The resistance generated by the test specimen during loading over the course of the test was recorded. The test specimens used were flat sheets (80 mm×34 mm×4 mm) provided with a V-shaped notch (60° C. tapering to a point, notch radius max. 0.05 mm). The test specimens were placed on the testing device so that the notch pointed downwards on the base side. Force was applied evenly on both sides of the notch via two ball plungers at a speed of 0.05 min/min. A deteimination was carried out in triplicate in a standard climate according to DIN 50-014-23/50-2. The test is terminated when the test specimen breaks into two halves or when the load drop is 99% of the maximum load. The fracture toughness was calculated accordingly.

It was possible to show that the use of a polycaprolactone-polysiloxane block copolymer (I) alone did not result in a sufficient increase in the fracture toughness. Although the fracture toughness was improved compared with the prior art (1) by using an additional siloxane compound (III), it was not increased, to the desired extent. According to the invention, however, by skillfully dividing the constituents into components a) and b) and by using small amounts of polypropylene glycol in combination with the block copolymer, it was possible to bring the fracture toughness to the desired higher level without a decline in the T_{G}.

1. A composition comprising components a), b) and c),
wherein component a) comprises:
1) from 75 to 99.5% by weight of a polymer based on epoxide compounds,
2) from 0.5 to 25% by weight of at least one polyhydric alcohol and
3) optionally additives,
wherein component b) comprises:
1) from 80 to 99% by weight of a curing agent which is suitable for curing the polymer based on epoxide compounds,
2) from 1 to 20% by weight of a polycaprolactone-polysiloxane block copolymer,
3) optionally an accelerator and
4) optionally additives, and
wherein component c) comprises: optionally an accelerator.

2. Composition according to claim 1, wherein the ratio of components a) and b) is determined in dependence on the epoxide equivalent of the resin and the equivalent mass of the curing agent used.

3. Composition according to claim 1, wherein the polymer based on epoxide compounds is selected from the group of the polyepoxides based on cycloaliphatic or aliphatic compounds, based on bisphenol A and/or F and advancement resins produced therefrom, based on tetraglycidyl-methylenedianiline (TGMDA), based on epoxidized halogenated bisphenols and/or epoxidized novolaks and/or polyepoxide esters based on phthalic acid, hexahydrophthalic acid or based on terephthalic acid, epoxidized o- or p-aminophenols, epoxidized polyaddition products of dicyclopentadiene and phenol, based on epoxidized flourenone bisphenols.

4. Composition according to claim 1, wherein the polyhydric alcohol is selected from glycols, in particular ethylene glycol, propylene glycol and/or polypropylene glycol, glycerols and/or sugar compounds.

5. Composition according to claim 1, wherein the curing agent is an anhydride, in particular tetrahydrophthalic anhydride (THPA), hexahydrophthalic anhydride (HHPA), methyltetrahydrophthalic anhydride (MTHPA), methylhexahydrophthalic anhydride (MHHPA), methylnadic anhydride (MNA), dodecenylsuccinic anhydride (DBA) or mixtures thereof.

6. Composition according to claim 1, wherein the curing agent is an amine, in particular a polyamine, polyamide, Mannich base, polyaminoimidazoline, polyetheramine and mixtures thereof.

7. Composition according to claim 1, wherein the polycaprolactone-polysiloxane block copolymer has the following structure 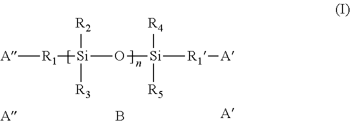
n: integer between 1 and 200,
R₂, R₃, R₄, R₅: identical or independently of one another selected from linear or branched alkyl, alkenyl, haloalkyl, haloalkenyl groups having up to 6 carbon atoms; aryl groups having from 5 to 7 carbon atoms or aralkyl groups having from 6 to 8 carbon atoms,
R₁′, R₁: identical or independently of one another selected from alkyl ethers or alkylamines having up to 7 carbon atoms,
A″ and A′: identical or independently of one another with 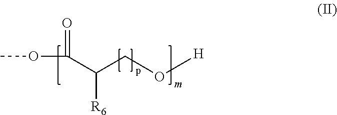
wherein
p: an integer from 1 to 6,
m: an integer from 1 to 25,
R₆: hydrogen or linear or branched alkyl groups having up to 6 carbon atoms.

8. Composition according to claim 7, wherein the polycaprolactone-polysiloxane block copolymer has the following structure: 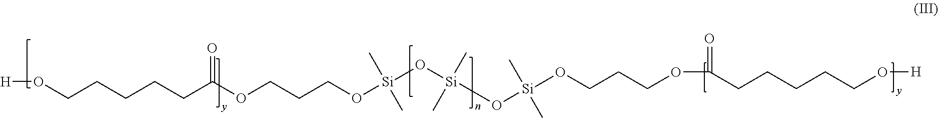
wherein n≧1 and y>3.

9. Process for the preparation of a cured composition, comprising the following steps:
preparing components a) and b) according to claim 1,
mixing components a) and b) and optionally c) according to claim 1 at temperatures up to 120° C.,
optionally shaping the mixture that is produced, and
curing the mixture at temperatures up to 180° C.

10. Cured composition comprising the components of claim 1 for the production of casting resins, composite compositions, coatings, adhesives and molding compositions.
